(19) United States
(12) Patent Application Publication
(10) Pub. No.: US 2008/0212812 A1
(43) Pub. Date: Sep. 4, 2008

(54) Hearing apparatus having a receiver compensation coil

(76) Inventors: Hoong Yih Chan, Singapore (SG); Thomas Kasztelan, Erlangen (DE); Wee Haw Koo, Singapore (SG)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/069,976

(22) Filed: Feb. 14, 2008

(30) Foreign Application Priority Data
Feb. 16, 2007 (DE) 10 2007 007 800.7

(51) Int. Cl. H04R 25/00

(52) U.S. Cl. 381/312

(57) ABSTRACT

A receiver of a hearing apparatus and in particular a hearing device is to be shadowed in a simple fashion against other magnetically sensitive components. To this end, an electrical coil is provided, which is attached directly to a segment of the receiver housing. The principle axis of the electrical coil is at right angles to the surface of the segment of the receiver housing. The electrical coil is also connected in series to the receiver. For compensation purposes, the electrical coil forms a corresponding counter field for the interference field of the receiver. A compensation coil of this type is easy to assemble and space-saving.

### CROSS REFERENCE TO RELATED APPLICATIONS

This application claims priority of German application No. 10 2007 007 800.7 filed Feb. 16, 2007, which is incorporated by reference herein in its entirety.

### FIELD OF THE INVENTION

The present invention relates to a hearing apparatus with a receiver, which has a receiver housing, and an electrical coil, which is attached directly to one segment of the receiver housing. The term hearing apparatus is understood here to mean in particular a hearing device, a headset, earphones or suchlike.

### BACKGROUND OF THE INVENTION

Hearing devices are portable hearing apparatuses which are used to supply the hard-of-hearing. To accommodate the numerous individual requirements, different configurations of hearing devices such as behind-the-ear hearing devices (BTE), in-the-ear hearing devices (ITE), e.g. including conch hearing devices or channel hearing devices (CIC), are provided. The hearing devices designed by way of example are worn on the outer ear or in the auditory canal. Furthermore, bone conduction hearing aids, implantable or vibrotactile hearing aids are also available on the market. The damaged hearing is herewith either stimulated mechanically or electrically.

Essential components of the hearing devices include in principal an input converter, an amplifier and an output converter. The input converter is generally a receiving transducer, e.g. a microphone and/or an electromagnetic receiver, e.g. an induction coil. The output converter is mostly realized as an electroacoustic converter, e.g. a miniature loudspeaker, or as an electromechanical converter, e.g. a bone conduction receiver. The amplifier is usually integrated into a signal processing unit. This basic configuration is shown in the example in FIG. 1 of a behind-the-ear hearing device. One or a number of microphones 2 for recording the ambient sound are incorporated in a hearing device housing 1 to be worn behind the ear. A signal processing unit 3, which is similarly integrated into the hearing device housing 1, processes the microphone signals and amplifies them. The output signal of the signal processing unit 3 is transmitted to a loudspeaker and/or receiver 4, which outputs an acoustic signal. The sound is optionally transmitted to the ear drum of the device wearer via a sound tube, which is fixed with an otoplastic in the auditory canal. The power supply of the hearing device and in particular of the signal processing unit 3 is provided by a battery 5 which is likewise integrated into the hearing device housing 1.

Receivers and/or loudspeakers in hearing devices generally operate according to the electrodynamic principle. The magnetic field generated in this process cannot be used fully and is partially lost as an interference field into the ambient. This unintentional ‘magnetic radiation’ is to be shielded. Otherwise the magnetic field of the receiver interferes with the telephone coil installed in the hearing device for instance.

To keep crackling noises as low as possible with telephone coil applications and to maintain the corresponding standards in respect of the electromagnetic interferences (EMI), so-called mu-metal sheets are used for instance, which outwardly shield the magnetic field of a receiver. Equipping hearing device amplifiers with compensation coils is also known, in order to likewise reduce the magnetic radiation of the receiver.

The publication US 2004/0028251 A1 also discloses a space-saving antenna arrangement for hearing devices. In this way, the antenna coil is wound around the receiver housing. The receiver housing material practically forms the core of the coil. The requirement is that the receiver housing is magnetically sealed so as to prevent the receiver coil from interfering with the antenna and/or telephone coil. This means that the magnetic field generated by the receiver coil is not able to outwardly reach the antenna coil. A complete decoupling of both coils can however only be achieved with difficulty. The coil wound around this receiver housing is not only used as an antenna coil, but can at the same be used as a compensation coil. To this end, the coil has several taps. However, a very complex component is thus produced and exchanging the receiver is always associated with exchanging the antenna coil for instance.

### SUMMARY OF THE INVENTION

The object of the present invention thus consists in proposing a simply structured receiver having an effective magnetic shielding.

In accordance with the invention, this object is achieved by a hearing apparatus with a receiver, which has a receiver housing and an electrical coil, which is directly fastened to a segment of the receiver housing, with the principal axis of the electrical coil being at right angles to the surface of the segment of the receiver housing and the electrical coil being connected in series with the receiver.

It is thus advantageously possible to produce a favorable receiver with effective magnetic shielding. In this way, the electrical coil can be directed to the receiver housing such that precisely the magnetically sensitive components in the hearing apparatus, e.g. the telephone coil, are shadowed.

The electrical coil is preferably configured to be helical. A coil with a small installation height can herewith be realized.

The electrical coil may also be an air-core coil. A coil core is herewith not needed, which is however generally not necessary for the magnetic shielding.

Furthermore, the electrical coil expediently has a polyimide substrate as a carrier. This can be used in particular as a foil. The foil carrier also allows the required space of the electrical coil to be reduced further. The polyimide also provides for an adequate electrical insulation and is also sufficiently mechanically robust.

### BRIEF DESCRIPTION OF THE DRAWINGS

The present invention is described in more detail with reference to the appended drawings, in which:

FIG. 1 shows the basic design of a hearing device as claimed in the prior art and

FIG. 2 shows the inventive design of a receiver with a compensation coil.

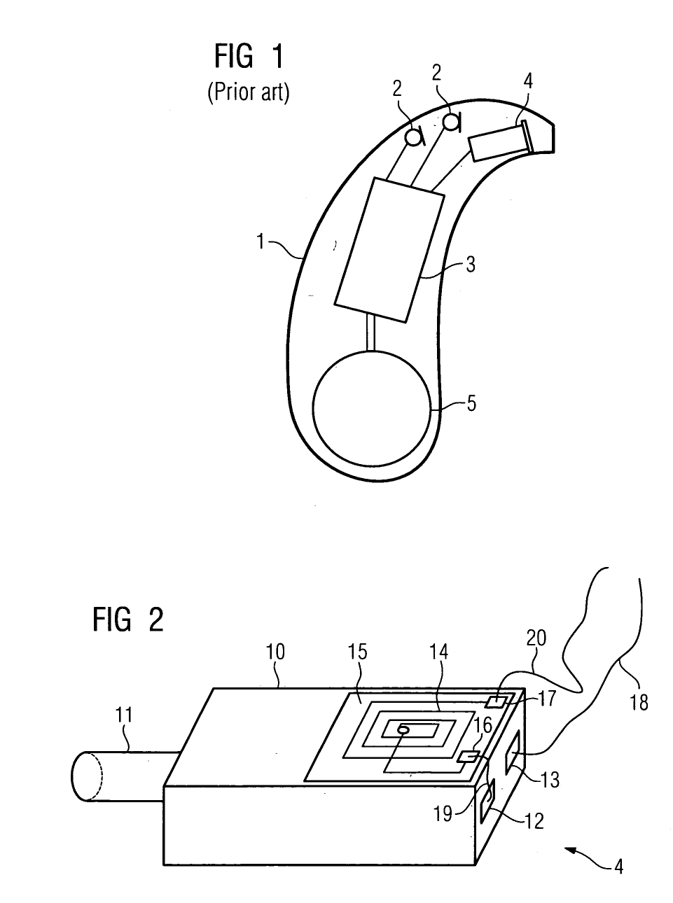

### DETAILED DESCRIPTION OF THE INVENTION

The exemplary embodiment illustrated in more detail below represents a preferred embodiment of the present invention.

The receiver 4 shown in the example of FIG. 2 has a receiver housing 10 and a connecting piece attached thereto as a sound outlet. The housing 10 is shown here in the manner of a cuboid but can also be configured for instance in the manner of a cylinder or in any other arbitrary form. The edges and corners may also be rounded.

Contacts 12, 13 for wiring the receiver 4 are arranged on the side of the receiver housing 10 facing the connecting piece 11. These contacts 12, 13 can naturally also be arranged on another point of the receiver housing 10.

In the example in FIG. 2, a helical air-core coil 14 is attached to the topside of the receiver housing 10. It is attached to a polyimide foil 15. Coil contacts 16, 17, which are connected to both ends of the coil 14, are also located on the polyimide foil 15.

Overall, the polyimide foil with the electrical coil 14 and the coil contacts 16, 17 is flexible and is adjusted to the surface of the receiver housing 10. The small installation height of the coil 14 and the foil 15 practically requires no additional space for this compensation coil. The polyimide foil 15, which forms the carrier of the coil 14, can be glued to the receiver housing 10 for instance. It thus covers a corresponding segment of the receiver housing 10. Overall, the size of the compensation coils 14, 15, 16, 17 can be selected such that in particular a telephone coil located in the hearing device is magnetically shadowed by the receiver 4.

The electrical coil 14 mainly extends in a plane which runs parallel to the surface segment of the receiver housing, onto which it is attached. Its principal axis is at right angles to this surface segment. This constellation can not only be achieved with a helical coil, but instead also with a coiled coil with a small number of winding turns for instance.

The operating principle of the air-core coil 14 consists in it forming the counter field to the interference field of the receiver 4. To this end, it is connected in series with the receiver coil (not shown in FIG. 2). In this way, the polarity of the air-core coil 14 is to be noted, so that the magnetic field generated thereby is directed in an opposing manner to that of the receiver coil. In the concrete example in FIG. 2, a first strand 18 is thus soldered onto the receiver contact 13 in order to operate the receiver with the compensation coil. A further strand 18 connects the second receiver contact 12 to the coil contact 16. Finally, a third strand 20 is again soldered onto the second coil contact 17. The receiver coil and the compensation coil are thus connected in series.

The particular advantage of this compensation lies in the fact that it takes place directly on the interference source. A relatively large spatial angle can thus be covered with a small compensation coil. The further advantage in that the compensation coil is very small was already mentioned. This is particularly significant for in-the-ear hearing devices, since only very little space is available there.

A further advantage of this type of compensation consists in each receiver receiving its own compensation. One is thus not dependent on the hearing device amplifier, on which compensation coils were arranged in many cases. This advantage is effective if two manufacturers are used as receiver suppliers for instance.

A further advantage finally worth mentioning is that mu-metal no longer needs to be installed in the hearing apparatus, and/or hearing device. Manufacturing costs are thus reduced. If however it is desirable or necessary in order to improve the shielding, the inventive compensation coil assembled on the receiver housing can also be combined with a mu-metal and one or a number of compensation coils on the amplifier.

1-6. (canceled)

7. A hearing apparatus, comprising:
a receiver comprising a receiver housing; and
an electrical coil connected in series with the receiver and fastened to a segment of the receiver housing,
wherein a principal axis of the electrical coil is configured to be perpendicular to a surface of the segment of the receiver housing.

8. The hearing apparatus as claimed in claim 7, wherein the electrical coil is a helical coil.

9. The hearing apparatus as claimed in claim 7, wherein the electrical coil is an air-core coil.

10. The hearing apparatus as claimed in claim 7, wherein the electrical coil comprises a polyimide substrate as a carrier.

11. The hearing apparatus as claimed in claim 10, wherein the carrier is a foil.

12. The hearing apparatus as claimed in claim 7, further comprising a telephone coil.

13. The hearing apparatus as claimed in claim 12, wherein the electrical coil shields a magnetic interference of the receiver from the telephone coil.

14. A method for shielding a magnetic interference in a hearing apparatus, comprising:
arranging a receiver in a receiver housing;
serially connecting an electrical coil with the receiver; and
fasten the electrical coil to a segment of the receiver housing with a principal axis of the electrical coil perpendicular to a surface of the segment of the receiver housing.
